(19) United States
(12) Patent Application Publication
(10) Pub. No.: US 2005/0040051 A1
(43) Pub. Date: Feb. 24, 2005

(54) Method and kit for teaching home cooking, food and wine pairing, and entertaining

(76) Inventor: Christine M. Martin, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/861,766

(22) Filed: Jun. 4, 2004

Related U.S. Application Data
(60) Provisional application No. 60/476,133, filed on Jun. 4, 2003.

(51) Int. Cl. A23G 3/00

(52) U.S. Cl. 206/215

(57) ABSTRACT

The present invention provides a system, method and kit for teaching cooking, food and wine pairing, entertaining, travel, culture, and floral arranging to home chefs all contained within a single package. The package may contain any items necessary to teach the preparation and arranging of the dining experience. Further, the package can contain instructions and lists of perishable food items which may be needed for the dining experience.

### RELATED APPLICATIONS

This application claims benefit under Title 35, United States Codes § 119(e) of U.S. provisional application 60/476,133, filed Jun. 4, 2003 in the United States Patent and Trademark Office, herein incorporated by reference in its entirety.

### FIELD OF THE INVENTION

The present invention relates to kits and methods which provide elements and correlated instruction for teaching home cooking, food and wine pairing, and entertaining. More specifically, the present invention relates to teaching gourmet cooking techniques, culture, foods and methods of preparation traditional to a restaurant, a region or population.

### BACKGROUND OF THE INVENTION

Home cooking and entertaining has long been one of the ways in which friends and family are celebrated. Traditionally, learning home cooking and entertaining was accomplished through the use of magazines, cookbooks, TV media and recipe websites via the Internet. In fact, home cooking has been used for several years and since the beginning home chefs have been relying on the frustrating unconnected sources as a means of learning home cooking.

The first cookbook printed in America was printed in 1752 in Williamsburg, Va. It was a reprint of Eliza Smith's The Complete Housewife which, at that time, was the most popular cookbook in England. In February 1963, Julia Child aired her first in the PBS television series The French Chef.

Since the instructions used in magazines, cookbooks, TV media and recipe websites are often difficult to use, any attempt at cooking detailed, gourmet meals usually met with failure since the home chef often unintentionally did not have the proper information, ingredients etc. which resulted in not achieving the desired dining experience.

### SUMMARY OF THE INVENTION

One embodiment is a kit which provides elements and correlated instruction for teaching home cooking and entertaining of a specific region, chef, restaurant or style for a specific number of people and has one or more instruction sheets, with instructions to purchase perishable ingredients, second instruction to prepare the meal; and non-perishable ingredients to prepare the meal, wherein said meal is specific to the restaurant, region, chef or style. In a further embodiment, the kit may also have instructions to select a suitable wine based on the meal prepared. In a further embodiment, the kit may also have instructions to create a suitable floral arrangement based on the meal prepared. Further instructions may include instructions to select a suitable music selection based on the meal prepared. In one embodiment the non-perishable ingredients are pre-measured for the specific number of people, including but not limited to between 1 and 20, preferably, 2, 4, 6, 8, and 10. In a further embodiment the non-perishable ingredients are spices. Other embodiments of the kit may contain any one of: candles, wine, napkins, scents, and music. The kit may also contain instructions and information specific to the restaurant, region, chef or style. The restaurant, region, chef or style can be, for example, North American, South American, European, Australian, African, Caribbean, Middle Eastern, Far Eastern Persian, Indian, Latin American, Native American, Southwestern, Cajun, Creole, Spanish, The non-perishable ingredients can be for example, flour, sugar, salt, spices, flavorings, vanilla, coffee, candy, icing, nuts, baking soda, baking powder, yeast, vinegar, oil, premixed ingredients, etc.

In a further embodiment, the kit may also contain perishable ingredients and be kept at a cooler temperature or frozen. Alternatively, one or more of the perishable ingredients may be provided separately from said non-perishable ingredients. Alternatively, advice may be given as to where or how to purchase the perishable ingredients. The kit may also contain a binder for loose leaf instructions tools to be packaged.

A further embodiment is a method for teaching home cooking and entertaining for a specific region, chef, or style, by providing the kit.

A further embodiment is a kit for use in teaching home cooking, having a plurality of sheets each having instructions for purchasing perishable ingredients necessary for preparing a meal, a plurality of sheets each having a menu, a plurality of sheets having a recipe a plurality of sheets each having instructions for teaching the culture, foods and methods of preparation traditional to the chef's specific restaurant, region or population and a plurality of sheets each having instructions for instructing the most suitable wine based on the meal prepared; a plurality of sheets having instructions for instructing the overall techniques of hosting a gourmet dinner, including table setting methods, based on the meal prepared, a plurality of sheets each having instructions for instructing the most suitable floral arranging methods based on the meal prepared, and a plurality of sheets each having instructions for instructing the most suitable music selection methods, and a plurality of sheets each having instructions for teaching the most suitable food nutrition. In one embodiment, the information is provided as an instruction booklet. In one embodiment, the sheets may be inserted into binders. Preferably, each of the sheets is detachably bound in an instruction book. In a further embodiment, the instruction book may be organized according to different criteria. In a further embodiment, the instruction book enables the cook to arrange binders by category such as region, chef, spice, essential cooking technique, menu, wine, etc. A further embodiment is a kit wherein said instruction sheets single size leaves in and others being oversized leaves in said book and folded to a single leaf size dimension.

### BRIEF DESCRIPTION OF THE DRAWINGS

FIG. 1 is a top view showing a kit with a plurality of contents according to a preferred embodiment for a Jardiniere dinner party.

FIG. 2 is an embodiment of a winery kit for Robert Mondavi.

FIGS. 3a-h are embodiments of instructions for the kit of FIG. 2.

FIG. 4 is an embodiment of a Thanksgiving kit according to a preferred embodiment.

FIG. 5a-g is an embodiment of instructions for a Persian cuisine kit.

FIG. 6 is an embodiment of a test for understanding of wines and pairings according to a preferred embodiment.

FIG. 7 is an instruction sheet as to how to peel tomatoes which could be included with any kit of the preferred embodiments.

FIGS. 8a-d are embodiments of advertisements and instructions which can be found with the kit or separately from the kit.

### DETAILED DESCRIPTION OF THE PREFERRED EMBODIMENTS

The present invention relates to kits and methods of teaching home cooking, food and wine pairing, and entertaining. More specifically, the present invention relates to teaching or instructing one or more of gourmet cooking techniques, food and wine pairing techniques, home entertaining techniques, the culture, foods and methods of preparation traditional to a chef's specific restaurant, region or population, floral arranging techniques, music selection techniques and food nutrition techniques to home chefs. All non-perishable components may be contained within a single package.

One embodiment of the kit comprises one or more instruction sheets having at least one of: first instructions for purchasing perishable ingredients necessary for preparing the meal; second instructions for teaching the culture, foods and methods of preparation traditional to the chef's specific restaurant, region or population; third instructions for teaching food and wine pairing techniques; fourth instructions for teaching flower arranging; fifth instructions for teaching music selection; sixth instructions for teaching food nutrition techniques; and seventh instructions on teaching the overall techniques of hosting a gourmet dinner. The kit may also contain pre-measured non-perishable ingredients, candles, cocktail and dinner napkins, napkin rings, invitations, place cards, glassware, plates, serving utensils, placemats, aprons, linens, bibs, matches, wine wheel, one or more menu cards, wine charms and music on CD-ROM.

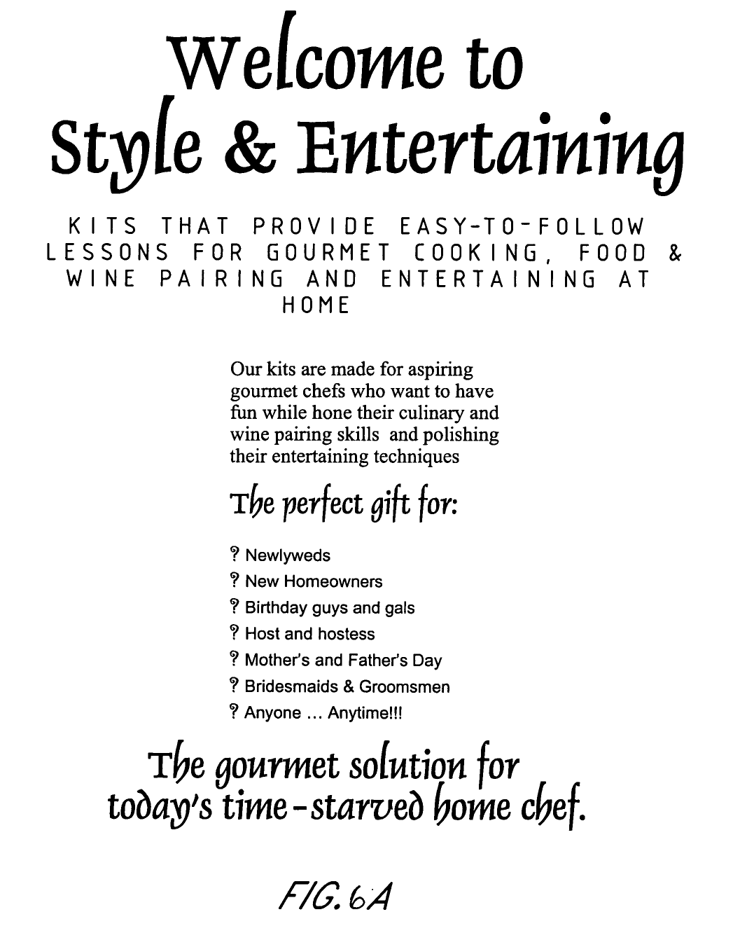

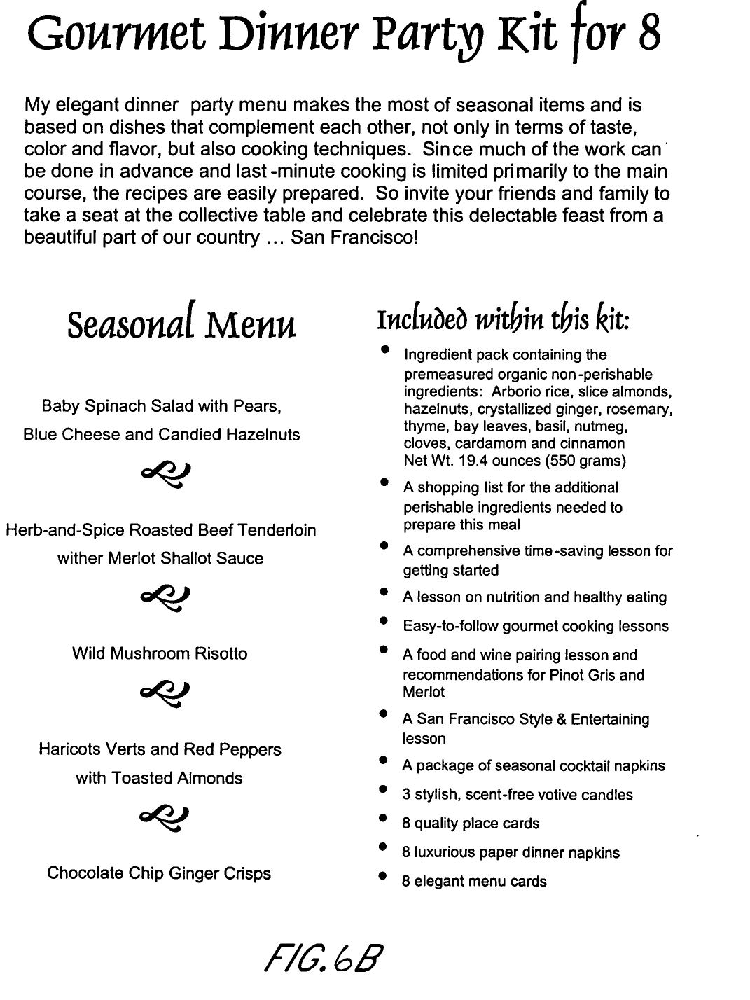

Preferably, said instruction sheet or sheets have at least two of the above instructions. In a further embodiment, the instruction sheets come in sets of at least three, including but not limited to four, five, six, and seven and all of the instructions listed above. The instruction sheets may additionally contain instructions specific to a particular kit, region or chef which might only be useful for that specific kit. Further instructions for various techniques specific to the kit may be included, such as methods of peeling tomatoes as shown in FIG. 7. The home chef may learn simply by the experience of preparing the dinner and reading the accompanying materials. Alternatively, tests or quizzes may be included to help the home chef to retain the information. One example of such a test is shown in FIG. 6.

One embodiment is a method which makes use of recipes from a home chef (such as the Applicant), or top chefs throughout the world teaching the culture, foods and methods of preparation traditional to the chef's specific restaurant, region or population. The method permits the home chef to experience preparing gourmet global cuisine, while also permitting them to have a choice in the selection of cuisine to be experienced.

A further embodiment is a kit comprising a plurality of pieces that are conducive to instructing a home chef to host a gourmet dinner. These pieces may be packaged within at least one container. The kit may have the plurality of pieces placed in a nested arrangement within the container. In this way a kit is presented that is easy to use and does not require bound cookbooks or magazines. The kit may also contain pre-measured non-perishable ingredients, candles, cocktail and dinner napkins, napkin rings, one or more menu cards, invitations, place cards, glassware, plates, serving utensils, placemats, aprons, linens, bibs, matches, wine wheel, wine charms and music on CD-ROM.

A further embodiment relates to teaching systems and methods for the preparation of a gourmet dinner by a home chef. More particularly, the present invention relates to a kit and method for teaching gourmet cooking techniques for preparing gourmet meals by home chefs. In one embodiment, home chefs can selectively choose to interact through cooking and cooking-related activities, as desired.

Cookbooks, TV shows, spices, candles, entertaining tips, nutritional tips, food and wine magazines and recipe websites have individually been available for years. However, the majority of cook books, magazines, TV cable services, Internet services and ingredients are sold separately. This individual retailing of the cookbooks separate from the spices, candles, music etc. creates several problems when preparing a meal. First, the majority of cookbooks require the home chef to select complementary recipes assuming they understand the best combination of tastes. Second, due to traditional packaging of spices, trying out any new recipe requires the home chef to often purchase quantities well above that necessary to prepare a meal, resulting in considerable expense. Third, once purchased, the home chef must measure spice for consumption and store the remaining spice in a remote location for possible eventual consumption. Generally these inconveniences to time, storage and money, make cooking less conducive to be enjoyed by home chefs. In fact the average home chef learns to make only two recipes from each cook book they purchase. Therefore, non-interactive cooking methods available to home chefs have not served as an optimal way to learn home cooking and how to entertain at home.

Thus, it is an object of the preferred embodiments to provide a substantially complete kit for providing a plurality of pieces and correlated instructions for easily preparing a gourmet dinner at home. Embodiments relate to teaching systems and methods, specifically to the preparation of a home cooked meal by a home chef. More particularly, the present invention relates to kits, systems and methods, for preparing home cooked gourmet meals. Accordingly, home chefs can selectively choose to interact through cooking and cooking-related activities, as desired.

Further development of home-based curricula and materials is needed for better engaging busy home chefs to participate in activities through the sharing of food, wine and home entertaining. Thus, embodiments allow for methods and materials for permitting a home chef to have a choice as to which fine dining meal he or she would like to experience, and for encouraging participation in activities through the sharing of cooking. In so doing this will teach the home chef some measure of subjects including history, culture, food and wine pairing, while at the same time permitting the home chef to experience gourmet cooking for its own sake. The kits, systems and teaching methods attempts to accomplish these goals.

The novel features which are believed to be characteristic of the invention, together with further advantages thereof, will be better understood from the following description considered in connection with the accompanying drawings in which preferred embodiments of the present invention are illustrated by way of example. It is to be expressly understood, however, that the drawings are for the purpose of illustration and description only and are not intended as a definition of the limits of the invention.

One preferred embodiment of the method of teaching home chefs through interactive cooking instructions in accordance with the present invention provides each home chef with instructions, including pages each having printed thereon one or more instructions as detailed above. In a further embodiment, the instructions may also have the shopping list for any of the items from the recipe which are not included, an itemized list of what is included in the kit, and any other information helpful or of interest to the home chef for that particular kit. Further, advertisements for web sites, books, stores or any other information pertinent to that specific kit may also be included. For example, for a kit which is specific for Indian food, advertisements for websites which may be used to purchase more Indian spices, music, books, and products may be included. Further, advertisements for similar kits may be included.

A further embodiment provides a kit containing substantially all of the elements necessary for preparing a gourmet dinner at home. In one embodiment, the perishable ingredients are provided in a separate package. In a further embodiment, the perishable ingredients are provided on a list. In a further embodiment, some perishable ingredients are provided in the same package and others are provided on a list or in a separate package. A further embodiment provides a kit that is self-contained and packaged in a unique manner for point of purchase display and sale. This kit presents a pleasing appearance for point of purchase display and sale.

A further embodiment is directed to a kit which provides most of the necessary elements and correlated instructions for learning how to prepare and for hosting a dinner. As such, the kit may include the recipes and identification of ingredients necessary for a person to recreate the experience of dining in a gourmet restaurant while dining in the comfort of their own home. Further, such a kit may include all but the perishable ingredients. Alternatively, the kit may contain some perishable ingredients and be stored in a refrigerator or freezer.

In one embodiment, the kit is used to help launch a new pharmaceutical. In this embodiment, the kit teaches gourmet cooking, food and wine pairing, and entertaining at home, but also teaches users how to cook for a specific diet or nutritional need. It is envisioned that should a pharmaceutical company want to launch a pharmaceutical to treat any disease which could be associated with a particular diet, a kit can be provided which is appropriate for the pharmaceutical. In this way, the patient is educated as to the dietary restrictions, or methods which would be helpful or necessary while taking the pharmaceutical. In one embodiment, a kit is included which is related or appropriate for the disease associated with the drug. For example, a drug used to treat hypertension could be included in a kit which teaches a meal and method of cooking with low sodium. Alternatively, a drug used to treat high cholesterol is included in a kit which teaches a meal and method for cooking a low cholesterol meal. Diseases for which the kit may be used include, but are not limited to, high blood pressure, cancer, obesity, depression, heart disease, stroke, and penile erectile dysfunction.

In a further embodiment, the kit is included with a kitchen appliance for the purpose of teaching the purchaser how to use the appliance or an aspect of the appliance. In this embodiment, the kit teaches gourmet cooking, food and wine pairing, and entertaining at home, but also teaches purchasers how to use a specific product to cook a meal. For example, a cookware company includes the kit with a new set of pans to teach the purchaser how to use and properly care for the pans.

Other alternatives of this pairing can be envisioned by one of skill in the art, including, but not limited to, dishwear, linens, small kitchen appliances, diet programs (for example, Atkins, Weight Watchers, Hollywood), specialty kitchen items, for example, waffle-makers, pie pans, a WEBBER GRILL, VIKING RANGE, ALL-CLAD cookware, etc.

A further embodiment is directed to a kit which provides for ordering the correct wine, flowers, and perishable ingredients from partners and affiliates necessary to preparing and hosting a dinner online or via a website.

A further embodiment is directed to a single-session educational and or reality Food TV show comprising a chef teaching a variety of people in the audience and at home the hands-on-techniques required to use the kit and how to produce the dinner party. This show could be used for instructional means or entertainment.

A further embodiment is directed to a cooking class and or demonstration comprising a chef teaching a variety of people in the audience the hands-on-techniques required to use the kit and how to produce the dinner party. This class and or demonstration could be used for instructional means or entertainment.

A further embodiment is directed to a kit which serves as a marketing tool enabling a restaurant, winery, cooking school, cookbook publisher, food and wine magazine, Food TV™ celebrity host, recipe website, supermarket and chef to extend their style, signature dishes and brand. As such, the kit may include private label ingredients.

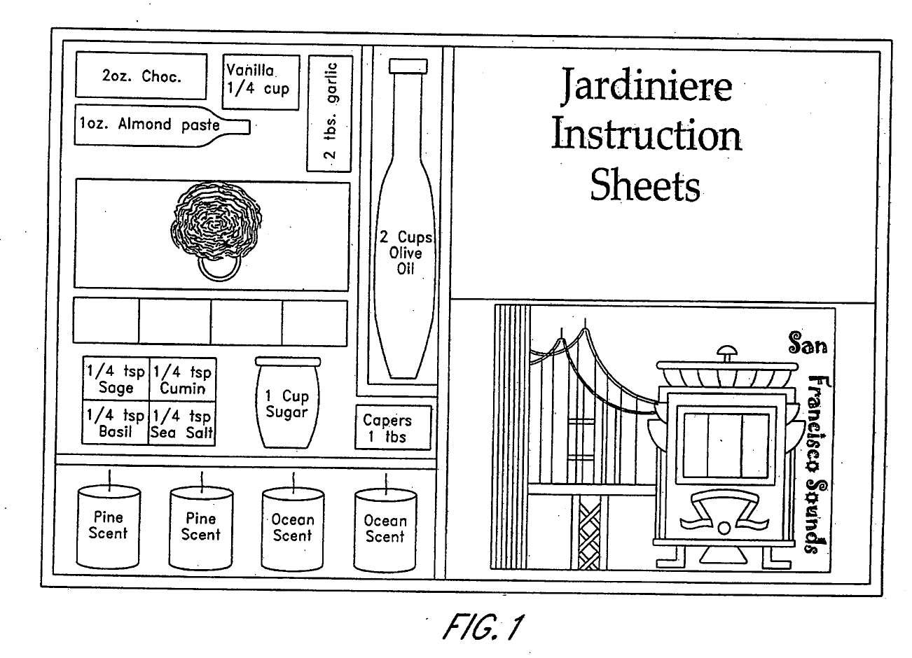

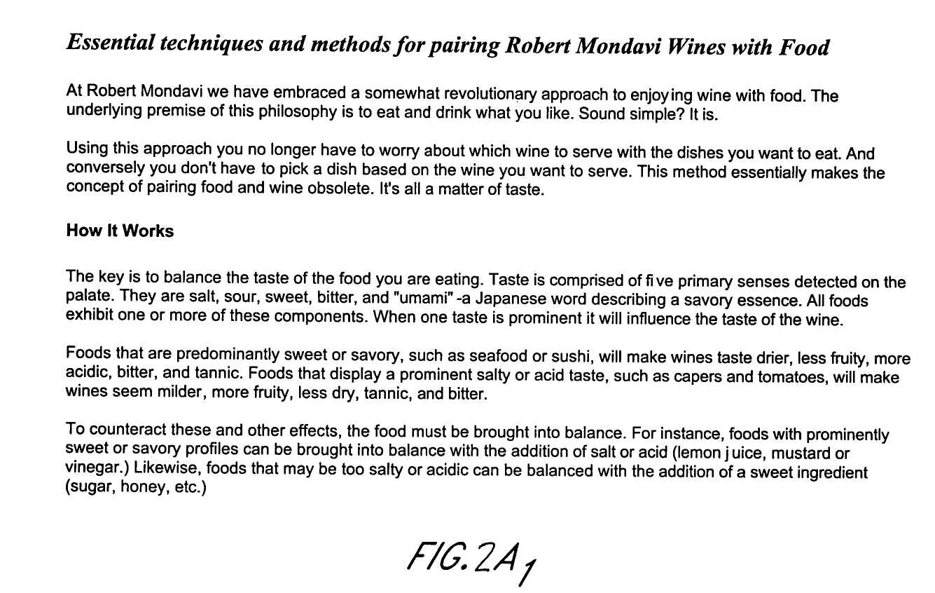

As is shown in FIG. 1, one embodiment of the kit is shown in its packaged form including a recipe book received in a clear plastic bag provided with a header displaying the trademark.

Generally, a kit may contain instruction sheets having a menu prepared by a home chef which includes signature dishes for one or more at appetizers, entrée, salad and dessert or some variation of the above, which enables the home chef to host an authentic chef inspired gourmet dinner at home. One preferred embodiment of a kit of the materials for practicing the various aspects of the teaching method of the present invention includes at least one of the following items: first instructions for purchasing perishable ingredients necessary for preparing the meal; second instructions for teaching the culture, foods and methods of preparation traditional to the chef's specific restaurant, region or population; third instructions for teaching food and wine pairing techniques traditional to the chef's specific restaurant, region or population; fourth instructions for teaching flower arranging traditional to the chef's specific restaurant, region or population; fifth instructions for teaching music selection traditional to the chef's specific restaurant, region or population; seventh instructions for teaching food nutrition techniques traditional to the chef's specific restaurant, region or population; sixth instructions on teaching the overall techniques of hosting a gourmet dinner traditional to the chef's specific restaurant, region or population; eighth pre-measured non-perishable ingredients; ninth candles, cocktail napkins and dinner napkins, napkin rings, and tenth music traditional to the chef's specific restaurant, region or population. Preferably, the kit further includes at least two of the above. More preferably, the kit further includes at least three or more of the above, including but not limited to: four, five, six, seven, eight, nine, ten, and all of the above.

Non-perishable ingredients to cook the meal can be any ingredients which have a shelf life of between 2 months and 10 years (or more) when left at room temperature. Examples of such ingredients includes but is not limited to: olive oil, anchovies, olives, capers, chocolate, flour, spices, sugar, salt, pepper, baking soda, baking powder, yeast, food coloring, vanilla, pre-mixed ingredients.

A region can be any area which has a specific type of food style, including but not limited to: the 7 continents, countries, cities, ethnic groups, regions of cities. Example of such regions include but are not limited to: San Francisco, Fisherman's Wharf, Washington, DC, Dupont Circle, Boston, the North End, New York City, Union Square, India, Persia, Iran, Cuba, Brazil, Jamaica, American Indian, Persian, Armenian, Cajun, Creole, Soul food, Australia, Africa, Europe, South America, Far East, Middle East.

Chefs can be any well-known chef who may or may not have a restaurant, cooking style, and/or television program. Restaurants rather than specific chefs may also be used. Examples of such chefs or restaurants include but are not limited to: Christine Marin, any home chef, Zuni Cafe™, The French Laundry™, Jardinere, Inn at Little Washington™, Olive's™, Michael Mina, George Marrone, Joanne Weir, Jacques Pepin, other award winning chefs.

A style can be any type of cooking which is particular to a holiday, time of year, and time of life, including but not limited to: children's parties, Christmas, Easter, Chanukah, Thanksgiving, Wedding, Professional Sports Events, Married, Single, Baby Shower, anniversary, birthday, bachelor party, and engagement party.

The kit can be configured to be used for any number of guests, including but not limited to 1, 2, 3, 4, 5, 6, 7, 8, 9, 10, 11, 12, 14, 16, 18, 20, 22, 24, 26, 28, and 30. However, it can be envisioned that a kit for two would be particularly useful for dating and married couples. It can further be envisioned that the more common dinner parties could be accommodated, particularly four, six, eight and ten. In one embodiment, the kit could be provided for multiples of two people such that one could always add a kit for two to a kit for 6 to produce a kit for eight. In this case, a variety of music particular to the region, country, restaurant or age group could be included in each kit such that they would not be exactly duplicative.

In a further embodiment, a separate container, book, binder, or notebook could be purchased to place the recipes, information, and or instructions into a collection. This could be used to refer back to in the future when producing the same dinner/dinner party. In some embodiments, the instruction book may be organized according to different criteria. Further, the instruction book can enable the cook to arrange binders by category, wherein the category is selected from the group consisting of: region, chef, spice, essential cooking technique, menu, and wine. In addition, some of said instruction sheets can include a plurality of instruction sheets detachably bound in the instruction book, some of said pattern sheets being single size leaves in the instruction book and other of said pattern sheets being oversized leaves in the book and folded to a single leaf size dimension.

In a further embodiment, instructions in the form of video instructions, a television program and or instructions via a webpage or the internet may be included in the kit or accessed via television or the internet.

The method and kit will now be described with reference to the examples below. The examples are provided for illustrative purposes only and are not to be construed as limiting upon the present invention.

### EXAMPLES

### Example 1

A Kit for Teaching the Home Chef to Prepare a Meal like Traci Des Jardins at Jardiniere.

The Traci Des Jardins kit comprises, one or more instruction sheets having a menu prepared by a restaurant chef which includes signature dishes for appetizers, entrée, salad and dessert which enables the home chef to host an authentic, chef-inspired gourmet dinner at home. One embodiment of this kit would be Traci Des Jardins at Jardiniere™ and a kit is shown in FIG. 1.

In addition to the menu instructions, the kit includes instructions for purchasing perishable ingredients useful for preparing the meal; second instructions for teaching the culture, foods and methods of preparation traditional to Traci Des Jardins at Jardiniere, San Francisco or Northern Californians; third instructions for teaching food and wine pairing techniques traditional to Traci Des Jardins at Jardiniere, San Francisco or Northern Californians; fourth instructions for teaching flower arranging traditional to Traci Des Jardins at Jardiniere™, San Francisco or Northern Californians; fifth instructions for teaching music selection traditional to Traci Des Jardins at Jardiniere™, San Francisco or Northern Californians; sixth instructions for teaching food nutrition techniques traditional to Traci Des Jardins at Jardiniere™, San Francisco or Northern Californians; and seventh instructions on teaching the overall techniques of hosting a gourmet dinner traditional to Traci Des Jardins at Jardiniere™, San Francisco or Northern Californians. The kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to Traci Des Jardins at Jardiniere™, San Francisco or Northern Californians (see FIG. 1).

### Example 2

A Kit for Teaching the Gome Chef to Prepare a Persian Dining Experience

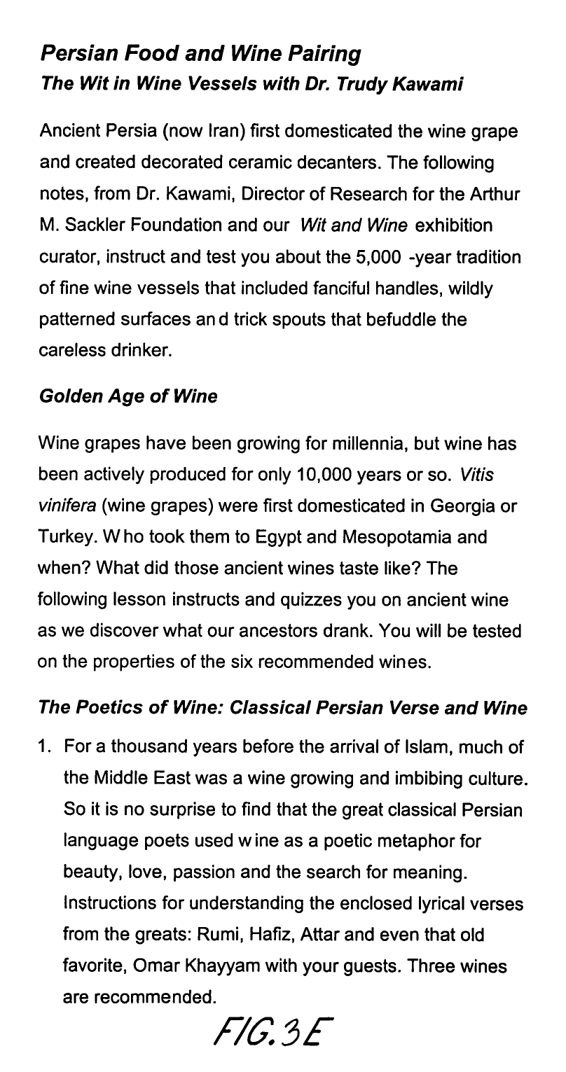

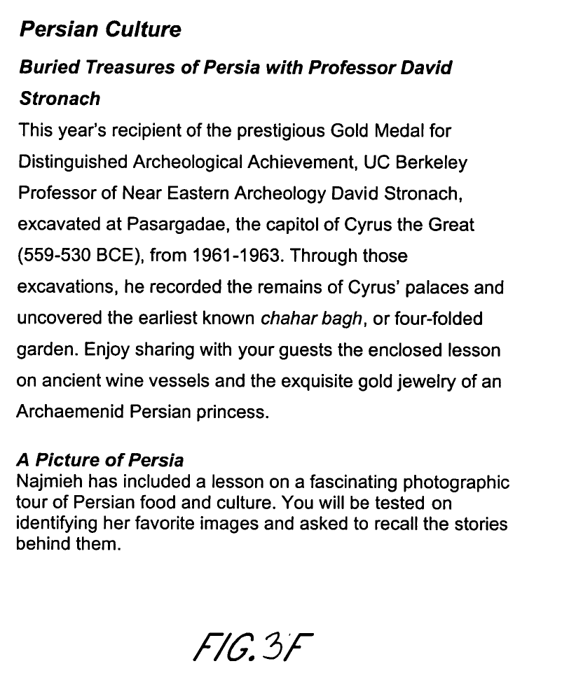

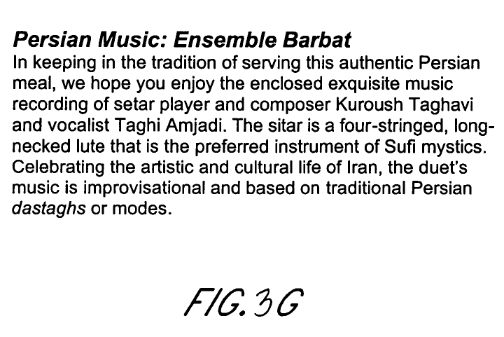

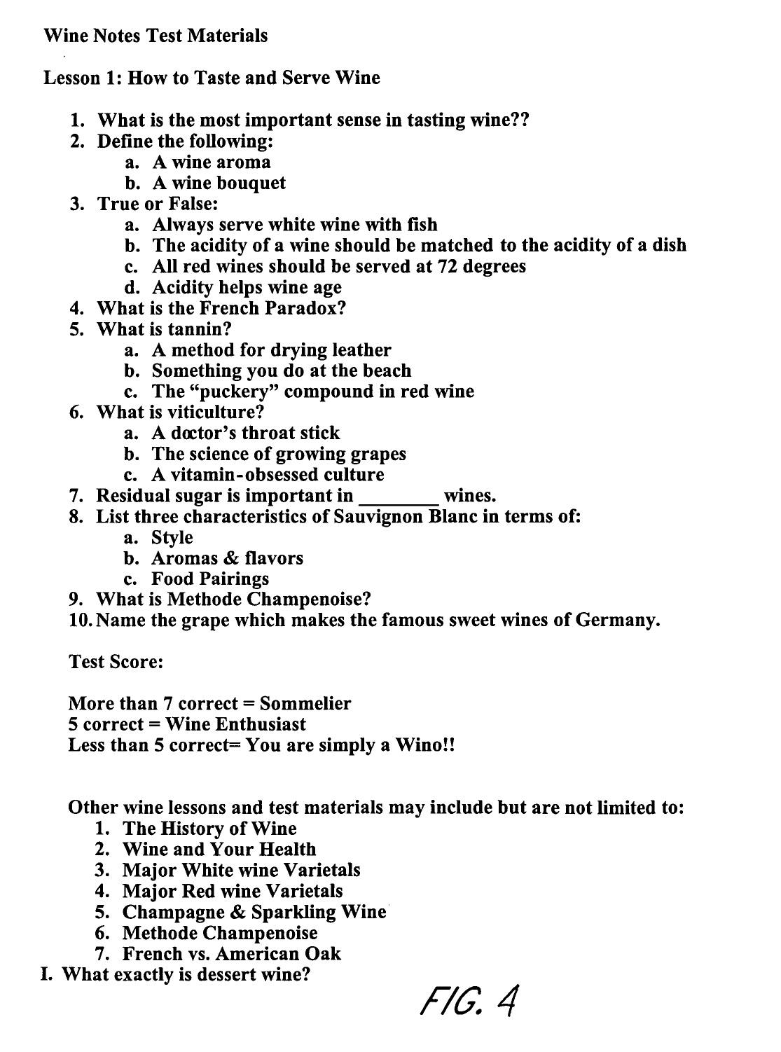

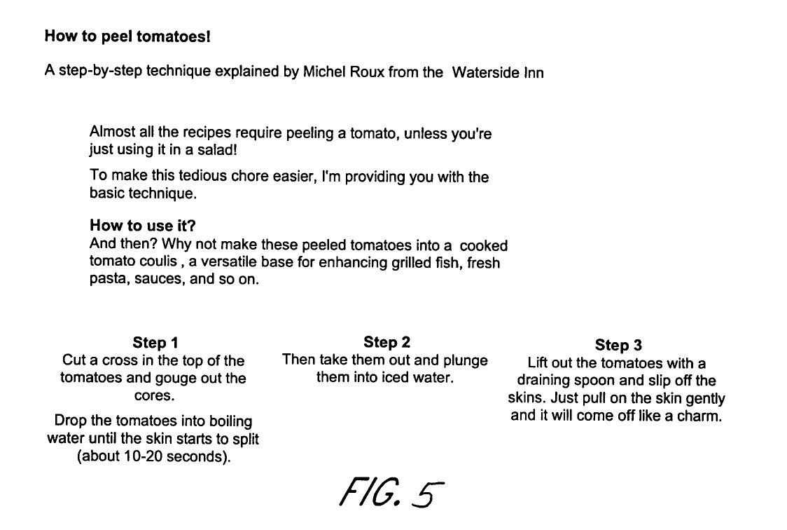

The Persian dining kit comprises, at least one or a combination of: one or more instruction sheets having a menu prepared by a chef which includes dishes traditional to the region or population of Iran thus teaching the home chef to prepare an authentic Persian dining experience in their home (see FIGS. 5a-g for the instructions and information about the culture and music).

In addition the kit includes first instructions for purchasing perishable ingredients necessary for preparing the meal; second instructions for teaching the culture, foods and methods of preparation traditional to Iran, the Middle East or Persians; third instructions for teaching food and wine pairing techniques traditional to Iran, the Middle East or Persians; fourth instructions for teaching flower arranging traditional to Iran, the Middle East or Persians; fifth instructions for teaching music selection traditional to Iran, the Middle East or Persians; sixth instructions for teaching food nutrition techniques traditional to Iran, the Middle East or Persians; and seventh instructions on teaching the overall techniques of hosting a gourmet dinner traditional to Iran, the Middle East or Persians (FIGS. 5a-g). The kit may also contain pre-measured, non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to Iran, the Middle East or Persians.

### Example 3

A Kit for Teaching the Home Chef to Prepare a Holiday Dining Experience

The Thanksgiving kit comprises, at least one or a combination of: one or more instruction sheets having a menu prepared by a chef which includes dishes traditional to celebrating Thanksgiving thus teaching the home chef to prepare an authentic Thanksgiving dining experience in their home (See FIG. 4).

In addition the kit includes first instructions for purchasing perishable ingredients necessary for preparing the meal, second instructions for teaching the culture, foods and methods of preparation traditional to celebrating Thanksgiving; third instructions for teaching food and wine pairing techniques traditional celebrating Thanksgiving; fourth instructions for teaching flower arranging traditional to celebrating Thanksgiving; fifth instructions for teaching music selection traditional to celebrating Thanksgiving; sixth instructions for teaching food nutrition techniques traditional to celebrating Thanksgiving; and seventh instructions on teaching the overall techniques of hosting a gourmet dinner traditional to celebrating Thanksgiving.

The kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to celebrating Thanksgiving.

### Example 4

A Kit for Teaching the Home Chef to Prepare a Meal like Annie Roberts, Executive Chef Robert Mondavi Winery.

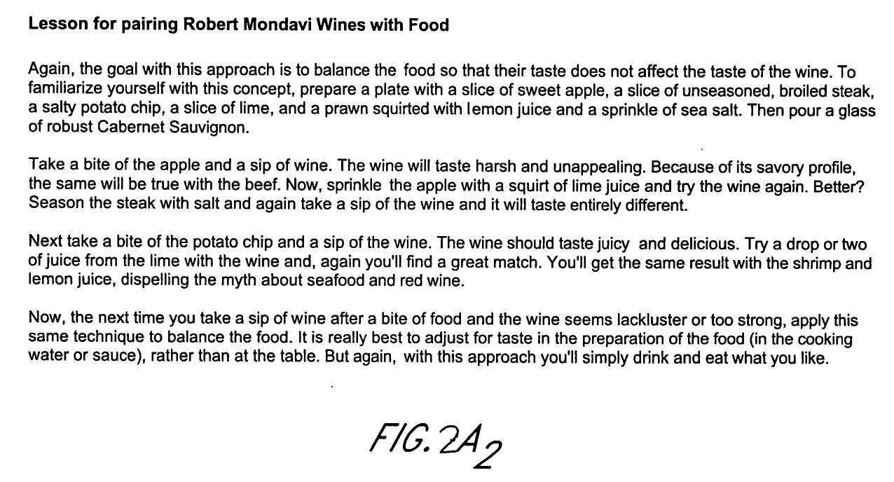

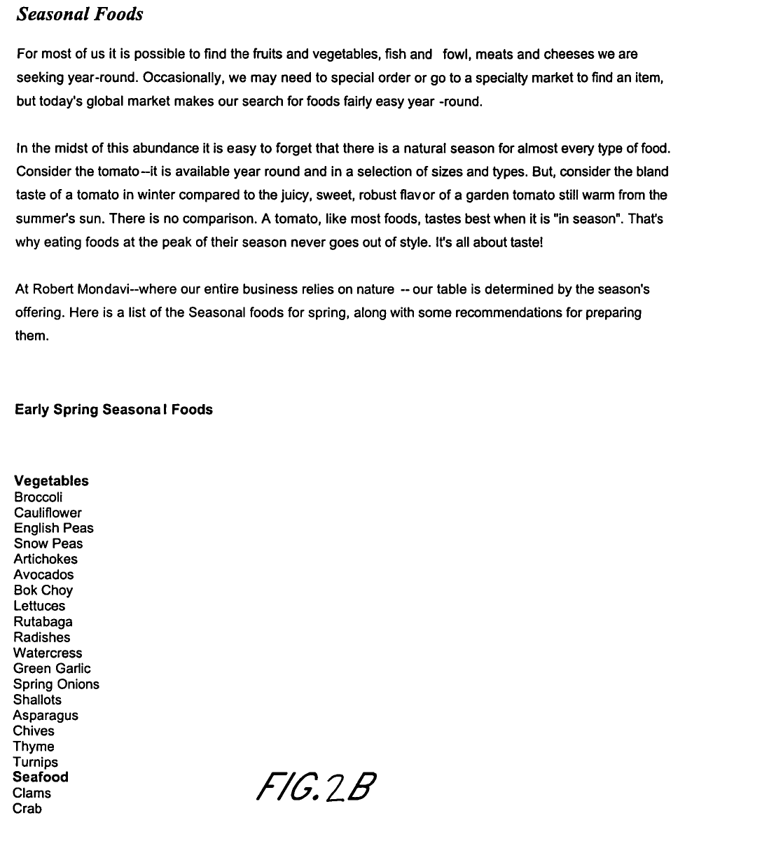

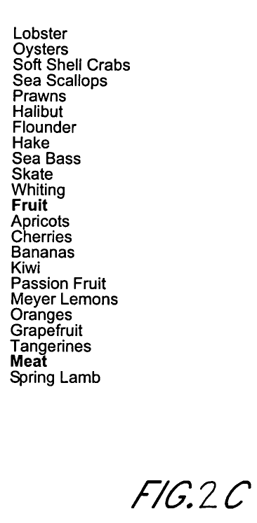

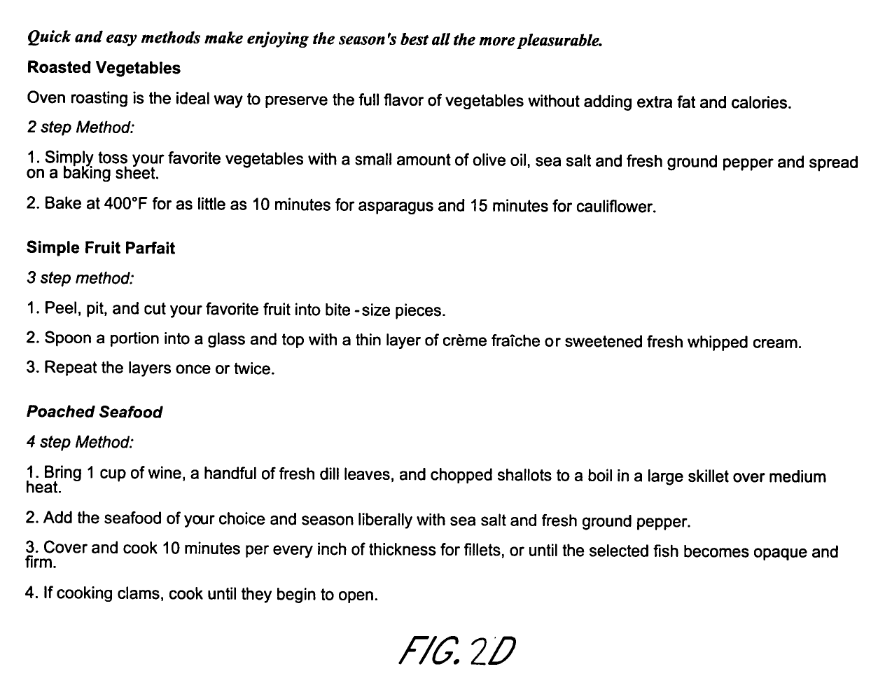

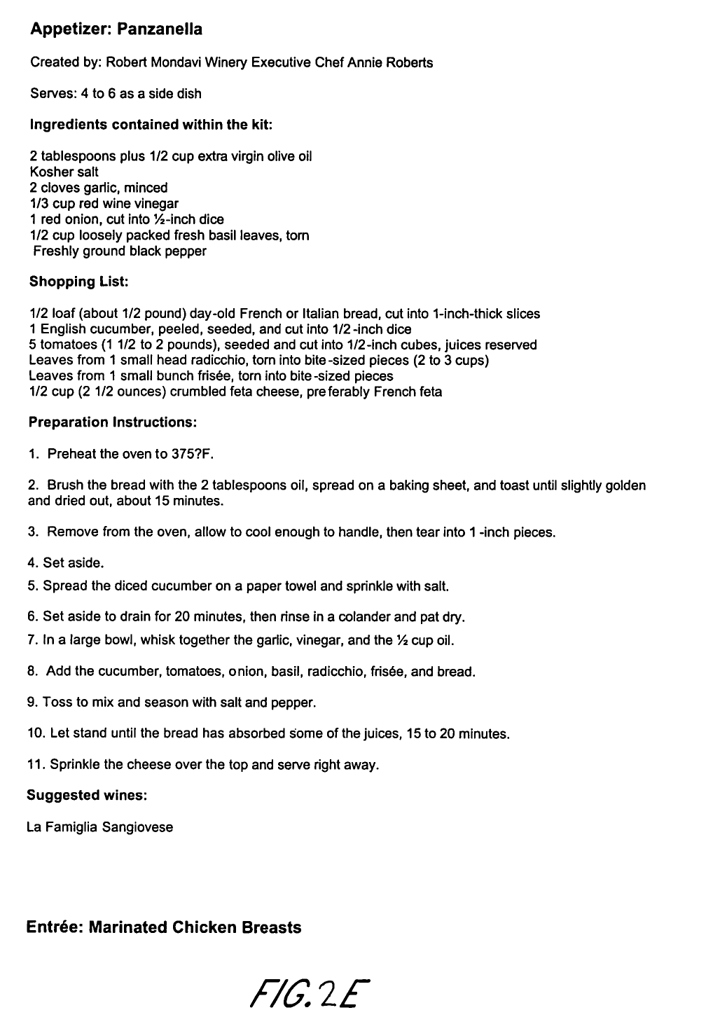

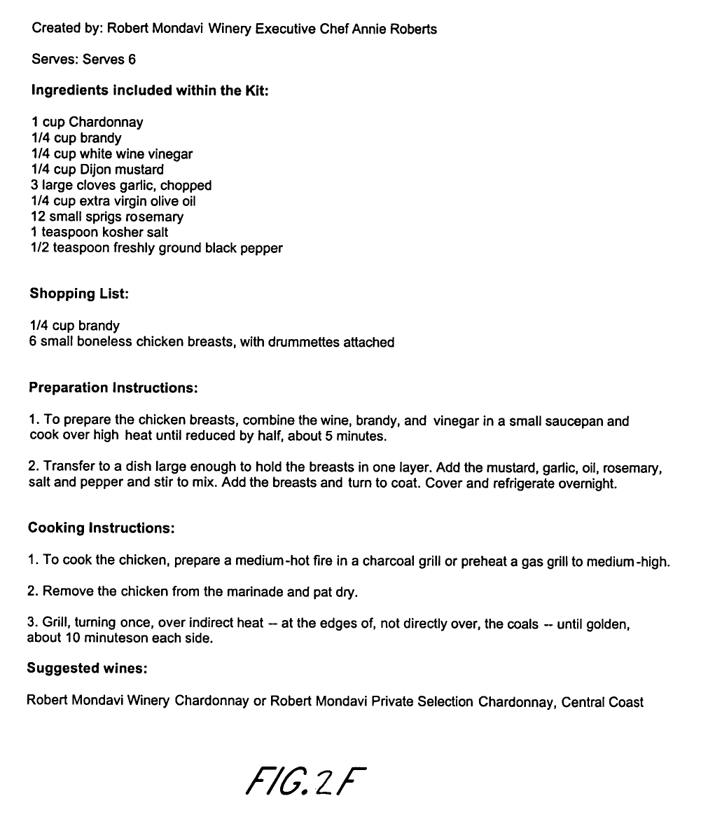

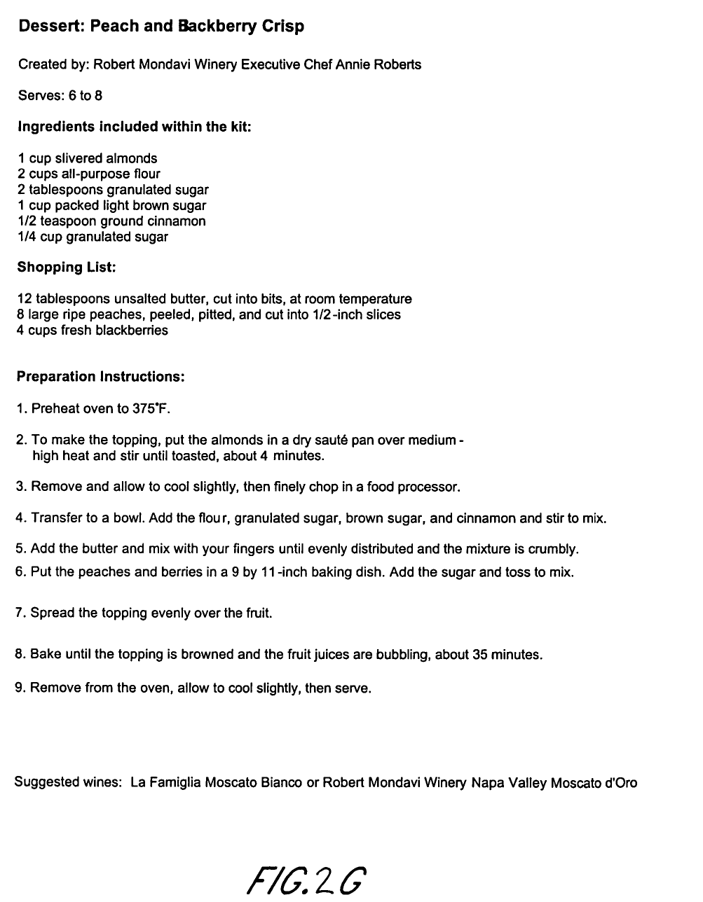

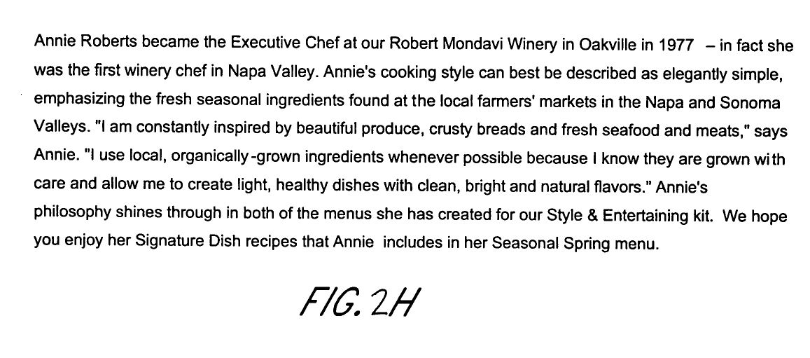

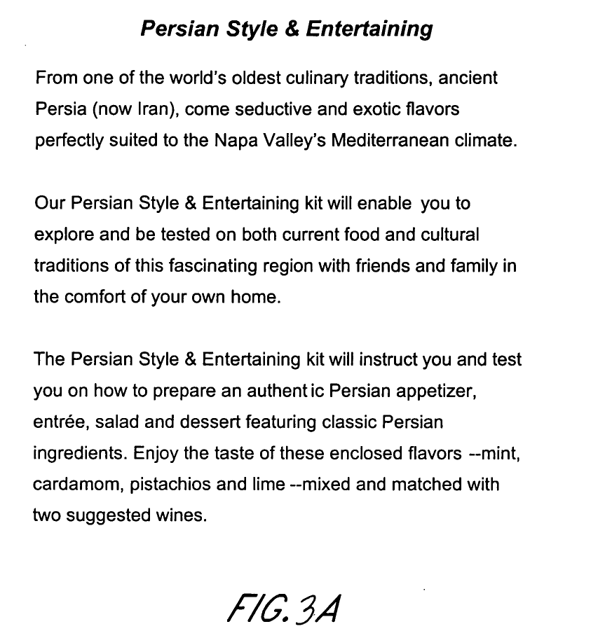

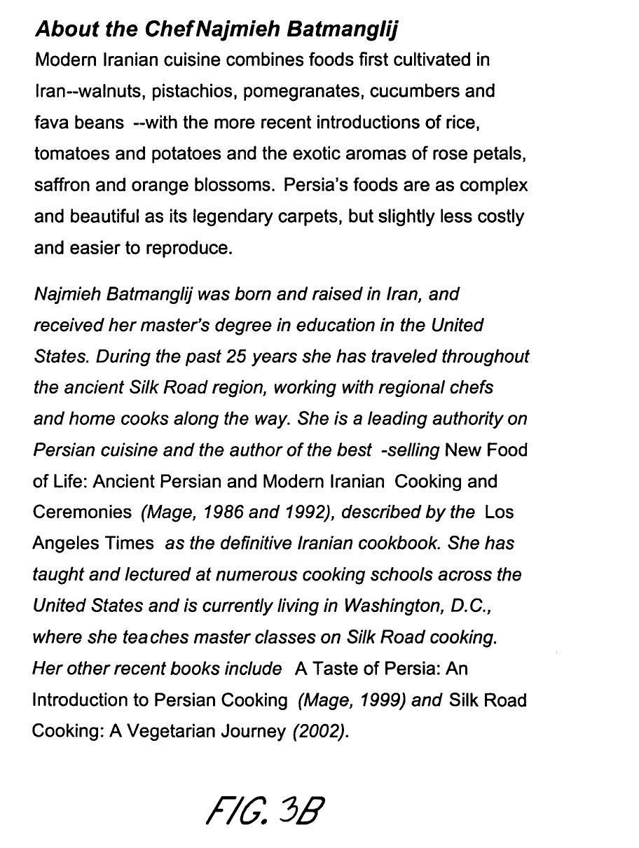

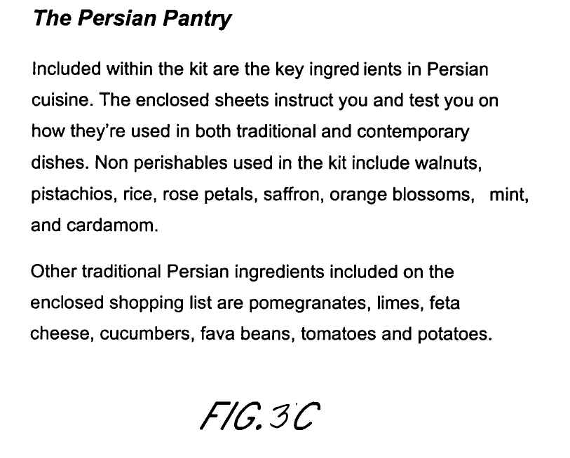

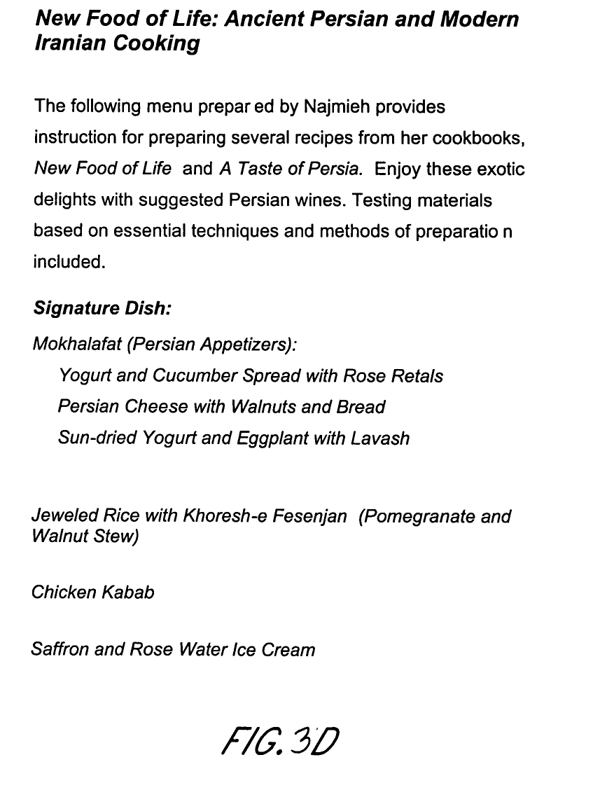

The Mondavi winery kit comprises one or more instruction sheets having a menu prepared by a Winery chef which includes signature dishes for one or more of appetizers, entrée, salad and dessert, which enables the home chef to host an authentic chef inspired gourmet dinner at home. One embodiment of this kit would be Annie Roberts at the Robert Mondavi Winery (see FIGS. 2 and 3a-h).

In addition as shown in FIGS. 3a-h the kit includes first instructions for purchasing perishable ingredients necessary for preparing the meal; second instructions for teaching the culture, foods and methods of preparation traditional to Annie Roberts at the Robert Mondavi Winery, Napa Valley or Wine Country; third instructions for teaching food and wine pairing techniques traditional to Annie Roberts at the Robert Mondavi Winery, Napa Valley or Wine Country; fourth instructions for teaching flower arranging traditional to Annie Roberts at the Robert Mondavi Winery, Napa Valley or Wine Country; fifth instructions for teaching music selection traditional to Annie Roberts at the Robert Mondavi Winery, Napa Valley or Wine Country; sixth instructions for teaching food nutrition techniques traditional to Annie Roberts at the Robert Mondavi Winery, Napa Valley or Wine Country; and seventh instructions on teaching the overall techniques of hosting a gourmet dinner traditional to Annie Roberts at the Robert Mondavi Winery, Napa Valley or Wine Country.

As shown in FIG. 2, the kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to Annie Roberts at the Robert Mondavi Winery, Napa Valley or Wine Country.

### Example 5

A Kit for Teaching the Home Chef to Prepare a Meal like a Cooking Class Taught by Joanne Weir at Sur La Table.

The Sur La Table kit comprises one or more instruction sheets having a menu prepared by a cooking school chef, which includes signature dishes for one or more of appetizers, entrée, salad and dessert, which enables the home chef to host an authentic chef inspired gourmet dinner at home. One embodiment of this kit would be a cooking class taught by Joanne Weir at Sur La Table™.

In addition the kit includes first instructions for purchasing perishable ingredients necessary for preparing the meal; second instructions for teaching the culture, foods and methods of preparation traditional to a cooking class taught by Joanne Weir at Sur La Table™; third instructions for teaching food and wine pairing techniques traditional to a cooking class taught by Joanne Weir at Sur La Table™; fourth instructions for teaching flower arranging traditional to a cooking class taught by Joanne Weir at Sur La Table™; fifth instructions for teaching music selection traditional to a cooking class taught by Joanne Weir at Sur La Table™; sixth instructions for teaching food nutrition techniques traditional to a cooking class taught by Joanne Weir at Sur La Table™; and seventh instructions on teaching the overall techniques of hosting a gourmet dinner traditional to a cooking class taught by Joanne Weir at Sur La Table™.

The kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to a cooking class taught by Joanne Weir at Sur La Table™.

### Example 6

A Kit for Teaching the Home Chef to Prepare a Meal like a Food TV Demonstration by Celebrity Chef Jamie Oliver.

The Jamie Oliver kit comprises one or more instruction sheets having a menu prepared by a chef, which includes signature dishes for one or more of appetizers, entrée, salad and dessert, which enables the home chef to host an authentic TV celebrity chef inspired gourmet dinner at home. One embodiment of this kit would be a Food TV™ demonstration by celebrity chef Jamie Oliver.

In addition the kit includes first instructions for purchasing perishable ingredients necessary for preparing the meal; second instructions for teaching the culture, foods and methods of preparation traditional to a Food TV™ demonstration by celebrity chef Jamie Oliver; third instructions for teaching food and wine pairing techniques traditional to a Food TV™ demonstration by celebrity chef Jamie Oliver; fourth instructions for teaching flower arranging traditional to a Food TV™ demonstration by celebrity chef Jamie Oliver; fifth instructions for teaching music selection traditional to a Food TVTM demonstration by celebrity chef Jamie Oliver; sixth instructions for teaching food nutrition techniques traditional to a Food TV™ demonstration by celebrity chef Jamie Oliver; and seventh instructions on teaching the overall techniques of hosting a gourmet dinner traditional to a Food TV™ demonstration by celebrity chef Jamie Oliver.

The kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to a Food TV™ demonstration by celebrity chef Jamie Oliver.

### Example 7

A Kit for Teaching the Home Chef to Prepare a Meal like a Recipe from a WILLIAMS SONOMA Cookbook.

A combination of instruction sheets having a menu prepared by a WILLIAMS SONOMA™ cookbook chef; which includes signature dishes for one or more appetizers, entrée, salad and dessert which enables the home chef to host an authentic chef inspired gourmet dinner at home. One embodiment of this kit would be a WILLIAMS SONOMA™ cookbook.

In addition the kit includes first instructions for purchasing perishable ingredients necessary for preparing the meal; second instructions for teaching the culture, foods and methods of preparation traditional to a WILLIAMS SONOMA™ cookbook; third instructions for teaching food and wine pairing techniques traditional to a WILLIAMS SONOMA™ cookbook; fourth instructions for teaching flower arranging traditional to a WILLIAMS SONOMA™ cookbook; fifth instructions for teaching music selection traditional to a WILLIAMS SONOMA™ cookbook; sixth instructions for teaching food nutrition techniques traditional to a WILLIAMS SONOMA™ cookbook; and seventh instructions on teaching the overall techniques of hosting a gourmet dinner traditional to a WILLIAMS SONOMA™ cookbook.

The kit may also contain pre-measured non-perishable ingredients, candles, cocktail and dinner napkins, napkin rings, invitations, place cards, glassware, plates, serving utensils, placemats, aprons, linens, bibs, matches, wine wheel, wine charms and music on CD-ROM traditional to a WILLIAMS SONOMA™ cookbook.

### Example 8

Commercial Embodiments

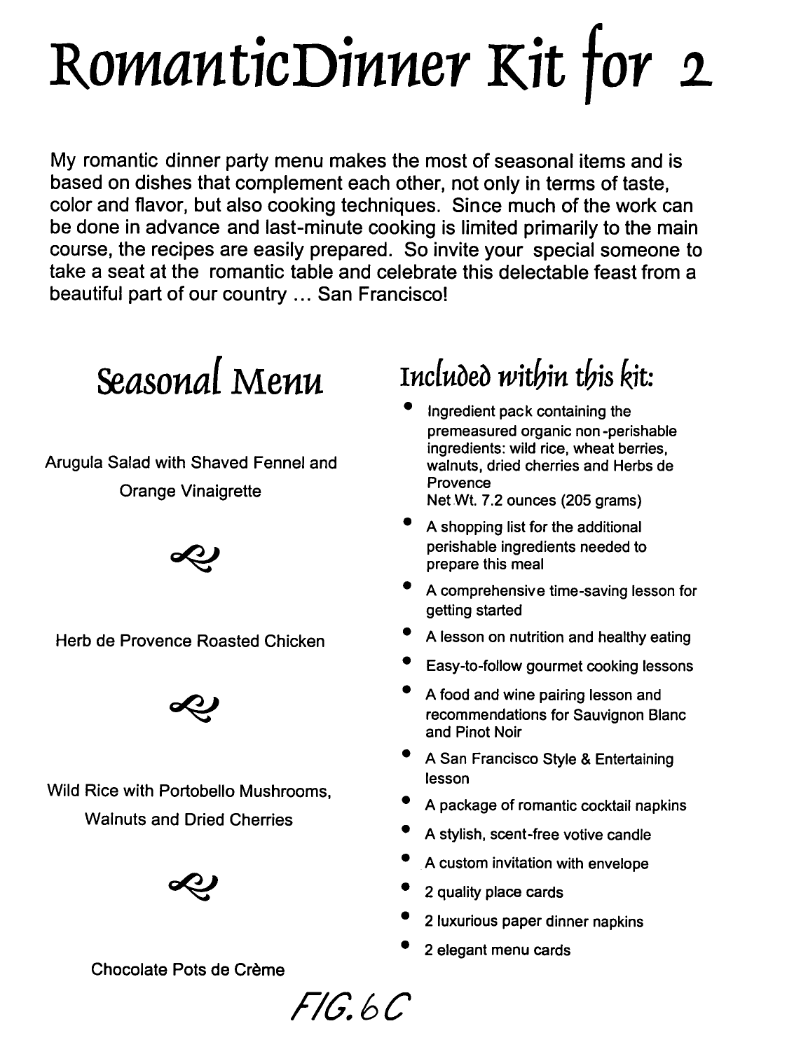

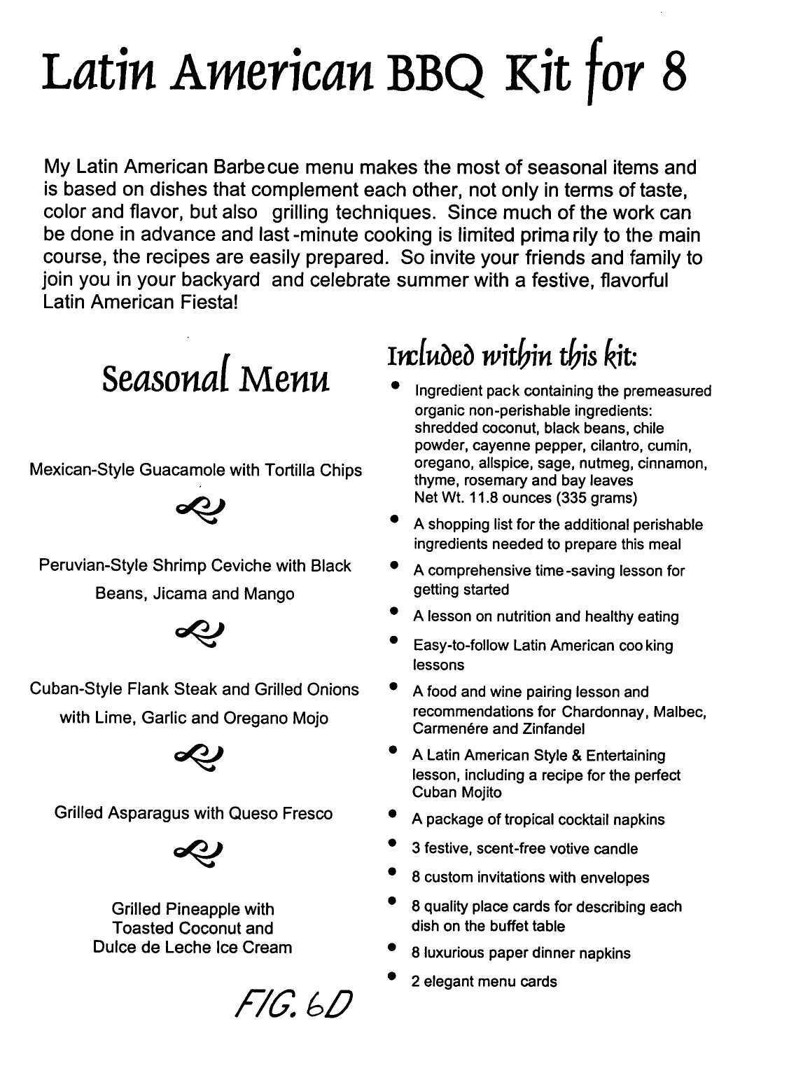

FIGS. 8a-8d provide commercial embodiments of three varieties of kits. A gourmet dinner kit party for 8 (FIG. 8b), a Romantic dinner kit for 2 (FIG. 8c), and a Latin American BBQ kit for 8 (FIG. 8d). The Figures include an explanation of the kit, the ingredients and nonperishable products which are included and the Menu. The kits are packaged as described herein and include lessons, shopping lists, information about the region if appropriate and other informative materials.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein, but instead by reference to claims attached

1. A kit which provides elements and correlated instructions for teaching home cooking and entertaining of a specific region, chef, restaurant or style for a specific number of people, comprising:
one or more instruction sheets, comprising
first instructions to purchase perishable ingredients; and
second instructions to prepare the meal; and
non-perishable ingredients to prepare the meal, wherein said meal is specific to the restaurant, region, chef or style.

2. The kit of claim 1, further comprising instructions to select a suitable wine based on the meal prepared.

3. The kit of claim 1, further comprising instructions to create a suitable floral arrangement based on the meal prepared.

4. The kit of claim 1, further comprising instructions to select a suitable music selection based on the meal prepared.

5. The kit of claim 1, wherein said non-perishable ingredients are pre-measured for the specific number of people.

6. The kit of claim 1, wherein the specific number of people is between 1 and 20.

7. The kit of claim 6, wherein the specific number of people is 2.

8. The kit of claim 6, wherein the specific number of people is 4.

9. The kit of claim 6, wherein the specific number of people is 8.

10. The kit of claim 1, wherein said non-perishable ingredients are spices.

11. The kit of claim 1, wherein said kit includes all non-perishable ingredients for following the instructions.

12. The kit of claim 1 further comprising candles.

13. The kit of claim 1, further comprising wine.

14. The kit of claim 1, further comprising napkins.

15. The kit of claim 1, further comprising instructions and information specific to the restaurant, region, chef or style.

16. The kit of claim 15, wherein said region is selected from the group consisting of: North American, Latin American, South American, European, Australian, African, Caribbean, Middle Eastern, Far Eastern Persian, Indian, Native American, Southwestern, Cajun, Creole, and Spanish.

17. The kit of claim 1 wherein said non-perishable ingredients are selected from the group consisting of: flour, sugar, salt, spices, flavorings, vanilla, coffee, candy, icing, nuts, baking soda, baking powder, yeast, vinegar, oil, and premixed ingredients.

18. The kit of claim 1, further comprising perishable ingredients.

19. The kit of claim 1, wherein said perishable ingredients are provided separately from said non-perishable ingredients.

20. A method for teaching home cooking and entertaining for a specific region, chef, or style, comprising:
providing the kit of claim 1.

21. A kit for use in teaching home cooking, comprising:
one or more sheets having instructions for purchasing perishable ingredients necessary for preparing a meal;
one or more sheets having a menu sheet;
one or more sheets having the recipe sheets;
one or more sheets having instructions for teaching the culture, foods and methods of preparation traditional to the chef's specific restaurant, region or population each;
one or more sheets having instructions for instructing the most suitable wine based on the meal prepared;
one or more sheets having instructions for instructing the overall techniques of hosting a gourmet dinner, including table setting methods, based on the meal prepared;
one or more sheets having instructions for instructing suitable floral arranging methods based on the meal prepared;
one or more sheets having instructions for instructing suitable music selection methods; and
one or more sheets having instructions for teaching the most suitable food nutrition, wherein said one or more sheets are part of a booklet.
